(19) United States
(12) Patent Application Publication
(10) Pub. No.: US 2012/0285589 A1
(43) Pub. Date: Nov. 15, 2012

(54) TREAD-REPLACEABLE ENVIRONMENTAL-PROTECTION WHEEL TIRE

(76) Inventor: BO-YUAN HUANG, Kaohsiung City 812 (TW)

(21) Appl. No.: 13/104,988

(22) Filed: May 11, 2011

(51) Int. Cl. B60C 11/02

(52) U.S. Cl. 152/209.1

(57) ABSTRACT

A tread-replaceable environmental-protection wheel tire includes a tire body and a tread layer. The tire body has two sides each having an end forming a bead section. The bead sections include reinforcement members embedded therein. The bead sections are positionable against a wheel rim. The tire body has a top face that forms fitting slots. The top face of the tire body has two side shoulders each forming a retention slot. The tread layer has a top surface forming tread patterns. The tread layer has a bottom surface forming fitting ribs raised therefrom. The fitting ribs are receivable into the fitting slots of the tire body. The tread layer has two side edges each forming a retention section. The retention sections are fixable in the retention slots of the tire body. As such, the applicability of wheel tire is expanded and the costs for replacing wheel tire are reduced.

### (a) TECHNICAL FIELD OF THE INVENTION

The present invention generally relates to a tread-replaceable environmental-protection wheel tire, and more particularly to a structure of wheel tire that allows a user to quickly replace a tread layer of the wheel tire to thereby reduce the cost for replacing wheel tire and improve applicability of wheel tire.

### (b) DESCRIPTION OF THE PRIOR ART

A wheel tire 1 for vehicle is made of natural or synthetic rubber materials and is composed of, as shown in FIGS. 1 and 2, bead sections 11, a tread layer 12, and reinforcement members 13. The bead sections 11 are provided for seating on a wheel rim 2. The tread layer 12 forms thereon tread patterns 121, of which the functionality is to expel water and improve frictional force induced by the wheel tire. The reinforcement members 13 are generally steel wires that are embedded in the bead sections 11 of the wheel tire 2 in order to provide improved pressure resistance to allow of increased loading capacity of the wheel tire 1.

In the use of the conventional wheel tire 1, the wheel tire 1 is positioned around an outer circumference of the wheel rim 2 and air is filled through a filling section (not shown) of the wheel rim 2 into the wheel tire 1. After the wheel tire 1 is filled with air to a predetermined level of pressure, the bead sections 11 of the wheel tire 1 tightly seat against the wheel rim 2 and the air so filled into the wheel tire 1 maintain a desired shape of the tire. To move a vehicle with the wheel tire 1, a frictional force is induced by the tread layer 12 of the wheel tire 1 with respect to a surface. Consequently, after a long term of use of the wheel tire 1, the tread layer 12 get severely wearing due to the friction with respect to the surface for a long period of time. An excessive wear of the tread layer 12 makes the tread patterns 121 over shallow and this indicates a replacement of the wheel tire 1 must be done, otherwise flat tire may occur that threaten driving safety.

Further, the conventional wheel tire 1 is generally made as a single piece. In other words, after the manufacture of the wheel tire 1, the tread patterns 121 of the wheel tire 1 are fixed. Thus, the application of the tread patterns 121 of the wheel tire 1 is fixed and so is the application of the wheel tire 1. For example, the wheel tire 1 may be provided for use on regular surface, or it may be adapted to poor surface (such as off-road surface). A user must use proper wheel tires 1 according to the surface where a vehicle is supposed to travel. This imposes a great limitation to the applicability of the conventional wheel tire 1 due to the structure thereof.

Further, when the tread layer 12 of a wheel tire 1 are worn to a predetermined extent, to reduce the costs of replacing brand new wheel tire 1, retreading of the wearing wheel tire 1 may be adopted, where the worn tread layer 12 is dressed and provided with a new tread layer 12a bonded thereto with adhesives, as shown in FIG. 3. Such a redressed tire is the so called retread tire. The retread wheel tire 1 is considered a common cause for loss control of a moving vehicle, which leads to traffic accidents.

Thus, it is desired to overcome the drawbacks of the conventional wheel tire 1 and eliminate the problems caused by retread wheel tire 1.

### SUMMARY OF THE INVENTION

To overcome the drawbacks of poor applicability of the conventional wheel tires and the excessively high costs for replacement of the wheel tires, an objective of the present invention is to provide a tread-replaceable environmental-protection wheel tire, which comprises a tire body and a tread layer. The tire body has two sides each having an end forming a bead section. The bead sections comprise reinforcement members embedded therein. The bead sections are positionable against a wheel rim. The tire body has a top face that forms fitting slots. The top face of the tire body has two side shoulders each forming a retention slot. The tread layer has a top surface forming tread patterns. The tread layer has a bottom surface forming fitting ribs raised therefrom. The fitting ribs are receivable into the fitting slots of the tire body. The tread layer has two side edges each forming a retention section. The retention sections are fixable in the retention slots of the tire body. As such, the applicability of wheel tire is expanded and the costs for replacing wheel tire are reduced.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will, become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a conventional wheel tire.

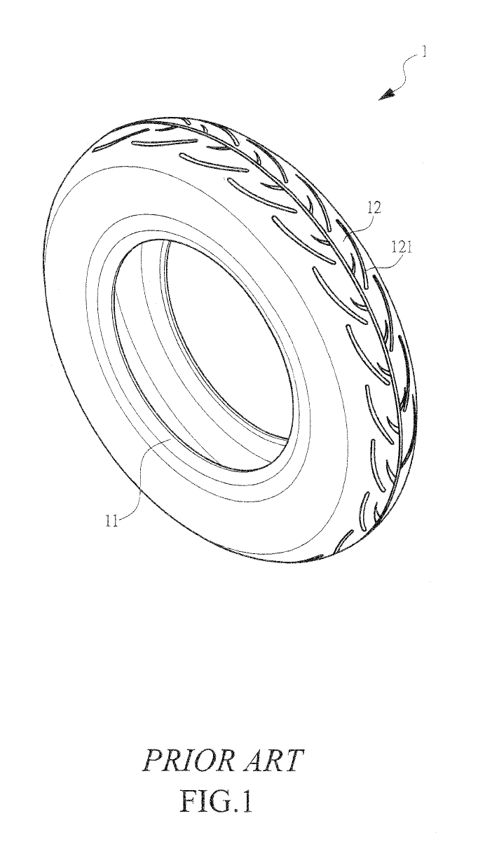

FIG. 2 is a cross-sectional view of the conventional wheel tire.

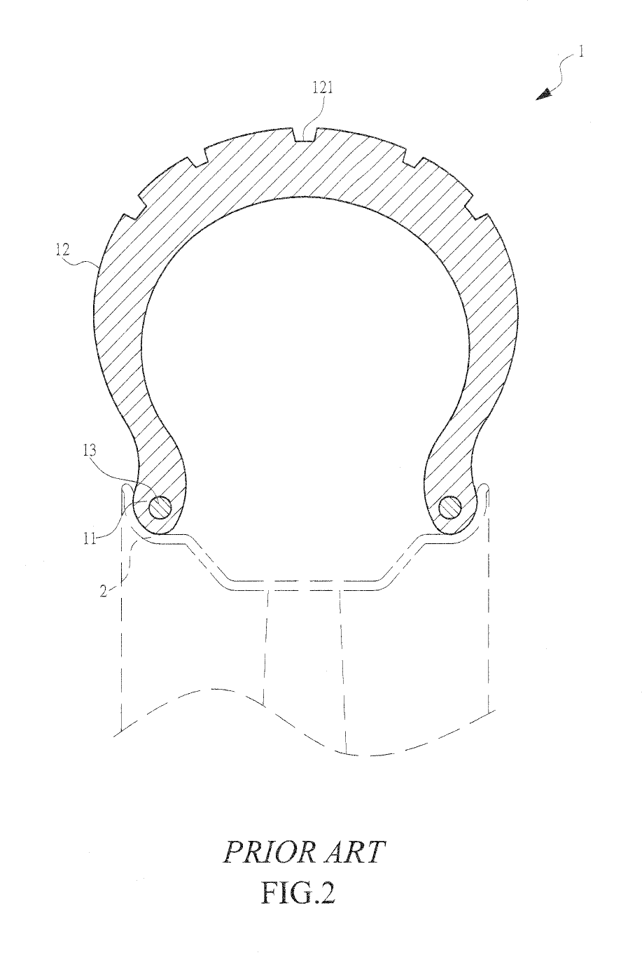

FIG. 3 is a cross-sectional view of another conventional wheel tire.

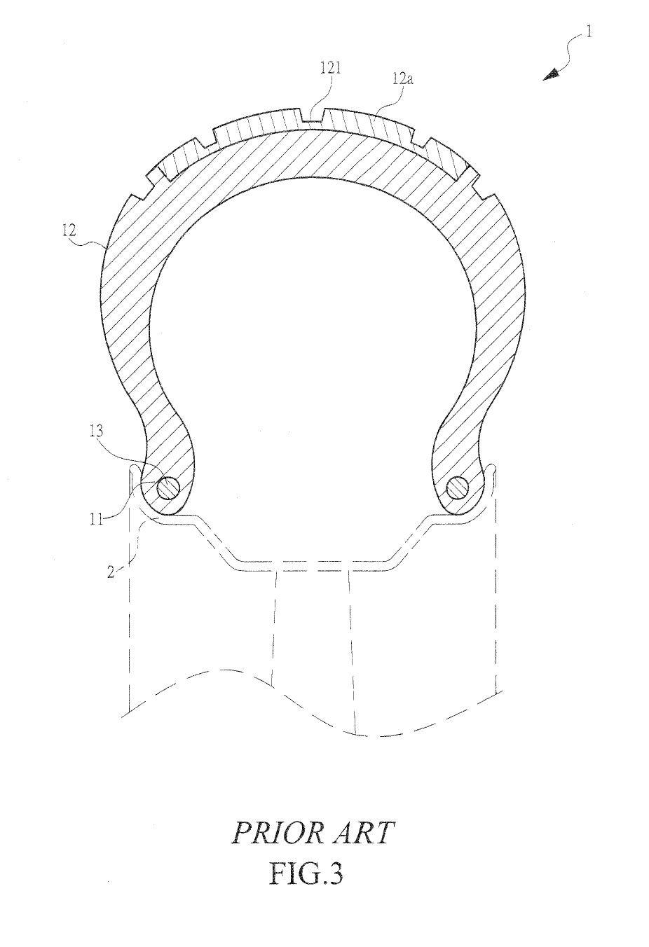

FIG. 4 is a perspective view showing a tread-replaceable environmental-protection wheel tire according to the present invention.

FIG. 5 is a cross-sectional view of the tread-replaceable environmental-protection wheel tire according to the present invention.

FIG. 6 is a cross-sectional view of a tread-replaceable environmental-protection wheel tire according to an embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

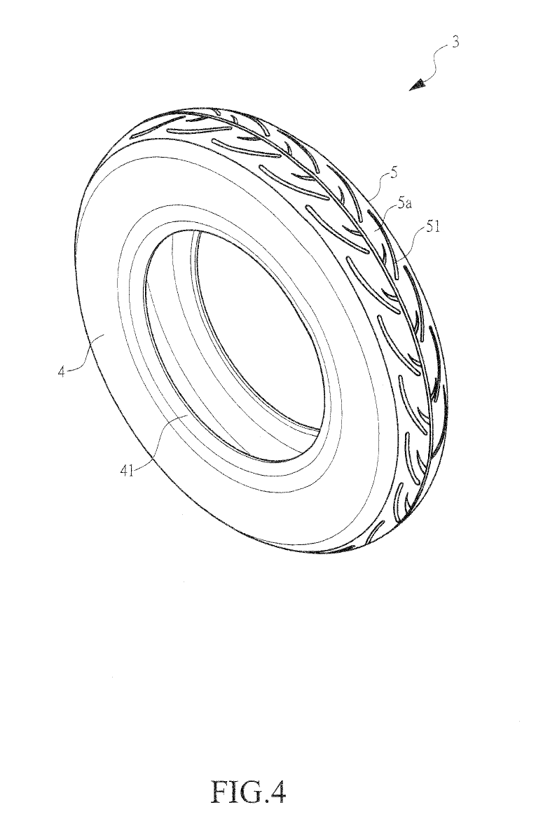

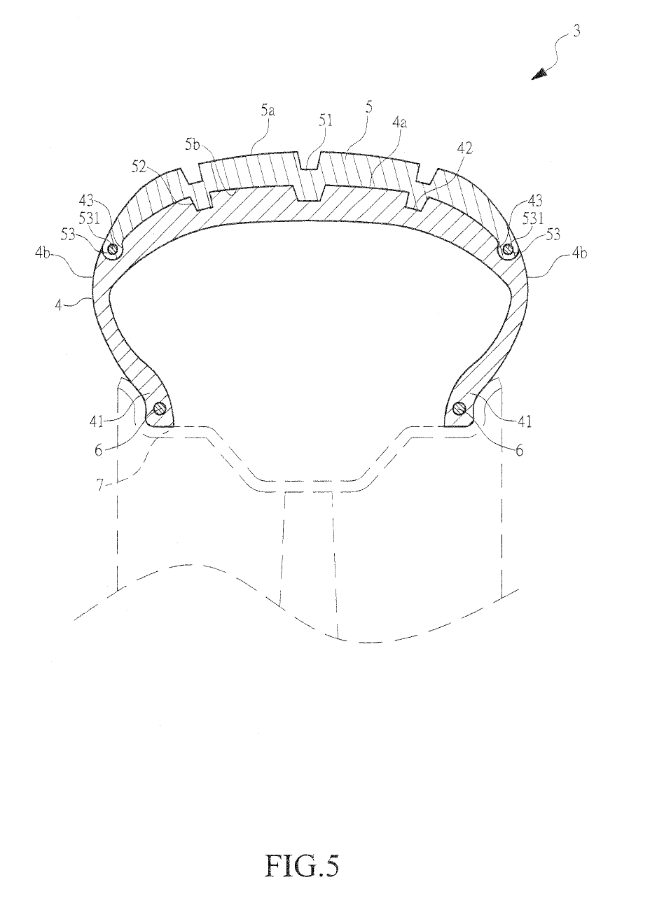

Referring first to FIGS. 4 and 5, the present invention provides a tread-replaceable environmental-protection wheel tire 3, which comprises a tire body 4 and a tread layer 5.

The tire body 4 has two sides each having an end forming a bead section 41. The bead sections 41 embeds therein reinforcement members 6 comprising of steel wires, whereby the bead sections 41 and the tire body 4 are made more pressure resistant and the loading capacity of the wheel tire 3 is improved. The bead sections 41 may seat tightly against a wheel rim 7. The tire body 4 has a top face 4a, which forms a plurality of fitting slots 42. The top face 4a of the tire body 4 has two side shoulders 4b, each forming a retention slot 43.

The tread layer 5 has a top surface 5a, which forms tread patterns 51. The tread layer 5 has a bottom surface 5b which forms fitting ribs 52 raised therefrom. The fitting ribs 52 correspond to the fitting slots 42 of the tire body 4 to allow the fitting ribs 52 to be fit into the fitting slots 42. The tread layer 5 has two side edges each forming a retention section 53. The retention sections 53 correspond to the retention slots 43 of the tire body 4 so as to allow the retention sections 53 to be retained in the retention slots 43. Further, the retention sections 53 comprise reinforcement members 531 formed of steel wires embedded therein to improve retention force of the retention sections 53.

To practice the tread-replaceable environmental-protection wheel tire 3 according to the present invention, referring to FIGS. 4 and 5, the retention sections 53 of the tread layer 5 are retained in the retention slots 43 of the tire body 4 and at the same time, the fitting ribs 52 of the tread layer 5 are received into the fitting slots 42 of the tire body 4 to form the tread-replaceable environmental-protection wheel tire 3 according to the present invention. As such, air can be filled into the tire through a filling section (not shown) of the wheel rim 7. When the tread-replaceable environmental-protection wheel tire 3 according to the present invention has been filled with air to a predetermined level of pressure, the bead sections 41 of the tire body 4 tightly seat against the wheel rim 7 and thus properly positioned. Meanwhile, the air pressure also inflate the tire body 4 to a desired extent, where the retention sections 53 of the tread layer 5 and the retention slots 43 of the tire body 4 for tight engagement therebetween to thereby securely retain and fix the tread layer 5 on the tire body 4. In other words, a tight engagement that resembles an integrated combination is formed between the tread layer 5 and the tire body 4 through engagement of the fitting ribs 52 and the retention sections 53 of the tread layer 5 with the fitting slots 42 and the retention slots 43 of the tire body 4. In the use of tread-replaceable environmental-protection wheel tire 3 according to the present invention, when the tread layer 5 is worn to such an extent as to require replacement, air is released from the wheel tire 3 through the filling section of the wheel rim 7. Once the air pressure (tire pressure) of the wheel tire 3 becomes insufficient to support the predetermined shape of the wheel tire 3, the tire body 4 and the tread layer 5 are turned into a loose engagement, which allows a user to remove the wearing tread layer 5 from the tire body 4 and to re-mount a substitute, new tread layer 5. Afterwards, air is re-filled through the filling section of the wheel rim 7. As such, a new tread-replaceable environmental-protection wheel tire 3 according to the present invention is completed.

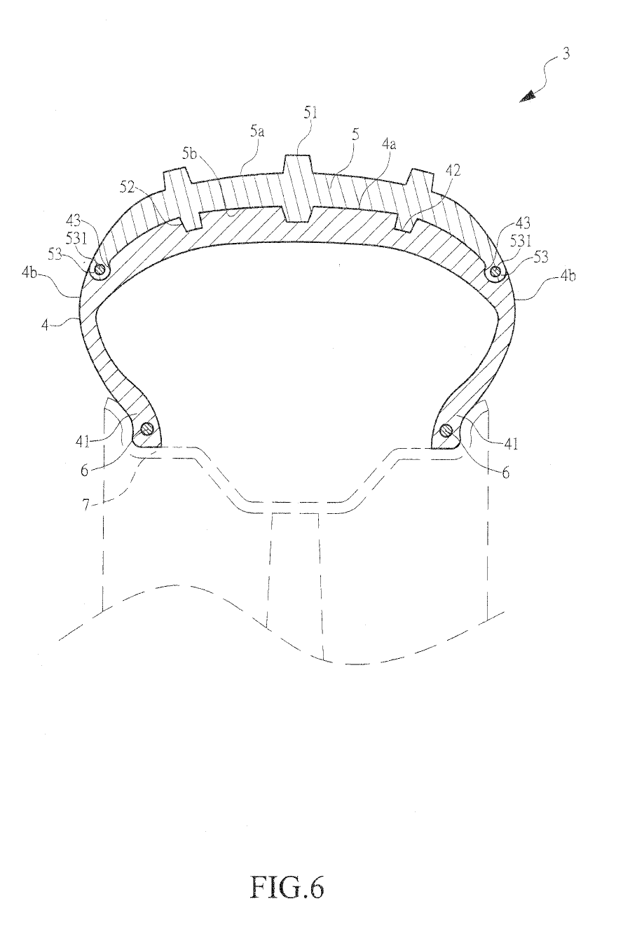

Referring to FIG. 6, in driving on a special surface (such as off-road surface or sandy surface), where coarse tread patterns 51 are needed, the user may partly release air from the wheel tire 3 through the filling section of the wheel rim 7 to such an extent that the air pressure (tire pressure) inside the wheel tire 3 is in sufficient to support the predetermined shape of the wheel tire 3, whereby the tire body 4 and the tread layer 5 are turned in a loose engagement, where the user may remove an original tread layer 5, which is of fine tread patterns 51, from the tire body 4, and then re-mount a tread layer 5 having coarse tread patterns 51. Afterwards, air is re-filled through, the filling section of the wheel rim 7 to fast turn the tread-replaceable environmental-protection wheel tire 3 according to the present invention into a wheel tire 3 that is adapted to a special surface (such as off-road surface or sandy surface).

The features of the tread-replaceable environmental-protection wheel tire 3 according to the present invention are that a tire body 4 is provided with fitting slots 42 and retention slots 43 and a tread layer 5 is provided with fitting ribs 52 and retention sections 53; the fitting ribs 52 are receivable into the fitting slots 42 and the retention sections 53 are fixed inside the retention slots 43; the retention sections 53 embeds therein reinforcement members 531 formed of steel wires, so as to improve retention force of the retention sections 53 for being fixed in the retention slots 43; when the tread-replaceable environmental-protection wheel tire 3 according to the present invention is filled with air to a predetermined level of pressure, bead sections 41 of the tire body 4 seat tightly against a wheel rim 7 for properly positioning and a tight engagement is formed between the retention sections 53 of the tread layer 5 and the retention slots 43 of the tire body 4 after the air pressure inflate the tire body 4 to a predetermined extent so that the tread layer 5 is tightly and securely retained on the tire body 4, namely a tight engagement that resembles an integrated combination is formed between the tread layer 5 and the tire body 4 through engagement of the fitting ribs 52 and the retention sections 53 of the tread layer 5 with the fitting slots 42 and the retention slots 43 of the tire body 4. As such, when the tread layer 5 is worn to such an extent as to require replacement, only the replacement of the tread layer 5 is needed and there is no need to replace the tire body 4. This save costs for replacing the wheel tire 3 and since the tire body 4 can be kept for reuse, the material consumption for wheel tire 3 is reduced thereby achieving the goal of environmental protection. Further, to drive on a special surface (such as off-road surface or sandy surface), similarly, it only needs to replace the tread layer 5 to provide the vehicle with a wheel tire 3 that is adapted to such a special surface (such as off-road surface or sandy surface), whereby the applicability of the wheel tire 3 is expanded.

It will be understood that each of the elements described above, or two or more together may also find a useful application in other types of methods differing from the type described above.

While certain novel features of this invention have been shown and described and are pointed out in the annexed claim, it is not, intended to be limited to the details above, since it will be understood that various omissions, modifications, substitutions and changes in the forms and details of the device illustrated and in its operation can be made by those skilled in the art without departing in any way from the spirit of the present invention.

I claim:

1. A tread-replaceable wheel tire, comprising a tire body and a tread layer;
the tire body having two sides each having an end forming a bead section, the bead sections comprising reinforcement members embedded therein, the bead sections adapted to be positionable against a wheel rim, the tire body having a top face that forms fitting slots, the top face of the tire body having two side shoulders each forming a retention slot; and
the tread layer having a top surface forming tread patterns, the tread layer having a bottom surface forming fitting ribs raised therefrom, the fitting ribs being receivable into the fitting slots of the tire body, the tread layer having two side edges each forming a retention section, the retention sections being fixable in the retention slots of the tire body.

2. The tread-replaceable wheel tire according to claim 1, wherein the fitting slots are formed in multicity.

3. The tread-replaceable wheel tire according to claim 1, wherein the fitting ribs correspond to the fitting slots.

4. The tread-replaceable wheel tire according to claim 1, wherein the retention sections comprise reinforcement members embedded therein.

5. The tread-replaceable wheel tire according to claim 1, wherein the reinforcement members comprise steel wires.

6. The tread-replaceable wheel tire according to claim 4, wherein the reinforcement members comprise steel wires.

7. The tread-replaceable wheel tire according to claim 1, wherein the retention sections correspond to the retention slots.
